(19) United States
(12) Patent Application Publication
(10) Pub. No.: US 2006/0079179 A1
(43) Pub. Date: Apr. 13, 2006

(54) Short-distance wireless transmission device for driving functions of medical equipment

(76) Inventor: Yuan-Yao Shen, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/962,507

(22) Filed: Oct. 13, 2004

(51) Int. Cl. H04B 7/00

(52) U.S. Cl. 455/41.2

(57) ABSTRACT

A short-distance wireless transmission device for driving functions of medical equipment, the short-distance wireless transmission device includes a data converting module and a signal emitting module integrated in an electronic product. As such, a user can input a control command via the electronic product, by means of the data converting module, the control command is converted into a common format data, and within an effective distance, a control signal is subsequently transmitted by the signal emitting module via a wireless transmission approach to medical equipment having therein a signal receiving module, thereby allowing the user to control and adjust medical equipment provided on his/her body in real time via a portable electronic communication product in the short-distance wireless transmission approach.

### BACKGROUND OF THE INVENTION

1. Field of the Invention

The invention relates to a short-distance wireless transmission device for driving functions of medical equipment, and in particular, to a short-distance wireless transmission device capable of allowing the user to control and adjust medical equipment provided on the use's body in real time via a portable electronic communication product.

2. Description of the Prior Art

Conventionally, the type of medical equipment is various, and proper medical equipment is equipped inside a patient's body by a physician according to the patient's condition. For example, a pacemaker is disposed in the user's body to adjust heartbeat. However, since the pacemaker is disposed within the body, once the pacemaker needs to be regulated, it should be removed from the body by undergoing an operation. This removing action not only leads to a heavy burden on the patient psychologically, but also results in a waste of medical resources. With development of medical technology, some medical equipment can be disposed inside or outside the patient's body as required. Such medical equipment is advantageous for the physician to realize the patient's condition. However, due to the inconvenience of controlling the medical equipment, such medical equipment is not user-friendly.

Accordingly, the conventional art mentioned above has still many disadvantages and is not designed perfectly such that it needs to be improved immediately.

In view of the various disadvantages associated with the prior art product, the inventor of this application had devoted to improve it and, after studying intensively for many years, accomplished successfully the present short-distance wireless transmission device for driving functions of medical equipment.

### SUMMARY OF THE INVENTION

It is an object of the present invention to provide a short-distance wireless transmission device capable of allowing the user to control and adjust medical equipment provided on the use's body in real time via a portable electronic communication product.

It is another object of the present invention to provide a short-distance wireless transmission device, which is advantageous for increasing safety and reducing waste of medical resources.

The short-distance wireless transmission device that can accomplishes the above-described objects according to the invention includes a data converting module and a signal emitting module integrated in an electronic product, for example a mobile phone, a personal digital assistant, a notebook computer, a panel computer, a pocket computer or an independent control device, such that the user can input a control command via the electronic product. By means of the data converting module, the control command is converted into a common format data. Subsequently, a control signal is transmitted by the signal emitting module via a wireless transmission approach such as an IR wireless transmission technology, a Bluetooth wireless transmission technology, an 802.11 wireless transmission technology or a wideband wireless transmission technology. As such, within an effective distance, the control signal can be transmitted to the medical equipment having therein a signal receiving module, for example, detecting equipment, testing equipment, monitoring equipment, therapeutic equipment, a pacemaker, a pump, a ultrasonic device, a microelectronic device, a biochip or a nano-device, thereby allowing the user to control and adjust medical equipment provided inside or outside his/her body in real time via a portable electronic communication product in a short-distance wireless transmission approach.

### BRIEF DESCRIPTION OF THE DRAWINGS

The drawings disclose an illustrative embodiment of the present invention which serves to exemplify the various advantages and objects hereof, and are as follows:

FIG. 1 is an architecture of a short-distance wireless transmission device for driving functions of medical equipment according to the present invention; and

FIG. 2 illustrates some implementation examples of the short-distance wireless transmission device for driving functions of medical equipment according to the present invention.

### DETAILED DESCRIPTION OF THE PREFERRED EMBODIMENT

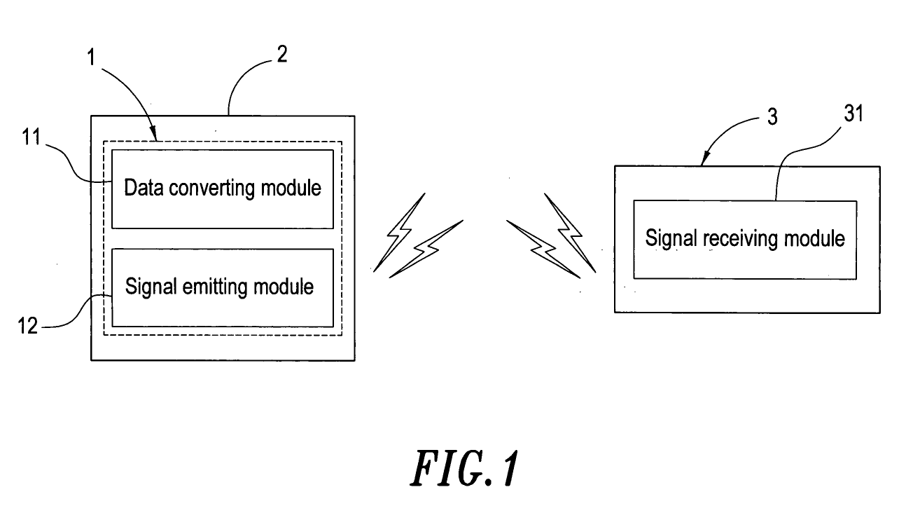

Referring to FIG. 1, the architecture of a short-distance wireless transmission device for driving functions of medical equipment according to the present invention is shown. The short-distance wireless transmission device 1 includes a data converting module 11 and a signal emitting module 12 integrated in an electronic product 2, for example a mobile phone, a personal digital assistant, a notebook computer, a panel computer, a pocket computer or an independent control device, such that the user can input a control command via the electronic product 2. By means of the data converting module 11, the control command is converted into a common format data. Subsequently, a control signal is transmitted by the signal emitting module 12 via a wireless transmission approach such as an IR wireless transmission technology, a Bluetooth wireless transmission technology, an 802.11 wireless transmission technology or a wideband wireless transmission technology, so as to output the control signal via a continuously emitting mode, an intermittently emitting mode, a regularly emitting mode, a manually operated mode, an automatically emitting mode, a preset command control mode or a receiver driving mode. As such, within an effective distance, the control signal can be transmitted to the medical equipment 3 having therein a signal receiving module 31. An example of the medical equipment 3 includes detecting equipment, testing equipment, monitoring equipment, therapeutic equipment, a pacemaker, a pump, a ultrasonic device, a microelectronic device, a biochip or a nano-device. In addition, such medical equipment can be disposed in the vicinity of the body, worn on the body, attached to the skin, implanted into hypodermis, implanted into the body, blood vessels or internal organs, swallowed into gastrointestinal tracts, or implanted via an endoscope, thereby allowing the user to control and adjust medical equipment provided on his/her body in real time via a portable electronic communication product in a short-distance wireless transmission approach.

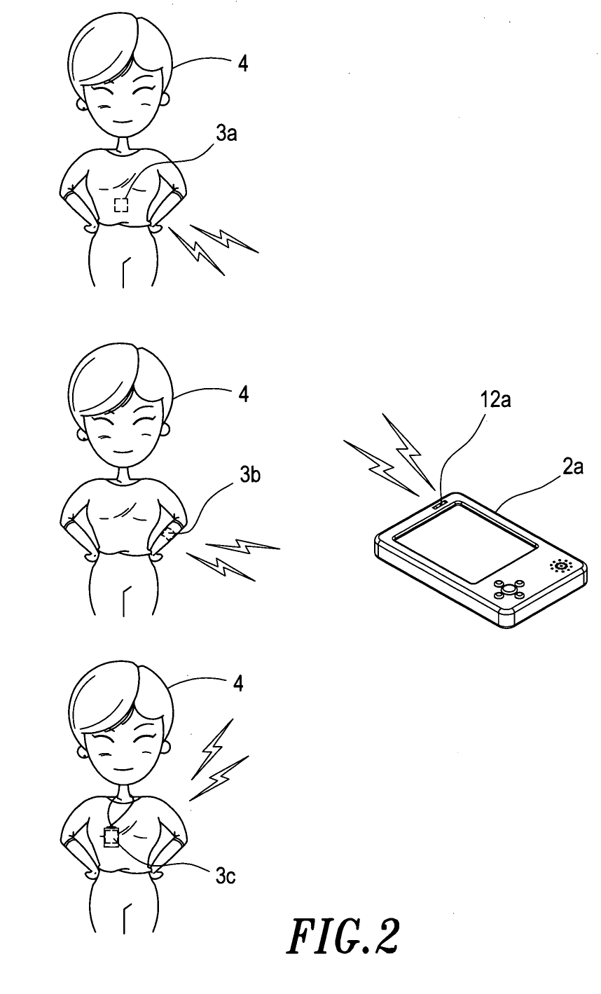

Referring to FIG. 2, some implementation examples of the short-distance wireless transmission device for driving functions of medical equipment according to the present invention are shown. A personal digital assistant 2a is provided thereon an IR emitter 12a . By means of the IR emitter 12a, a converted control signal can be transmitted via an IR wireless transmission technology to a pacemaker 3a disposed inside the body of the user 4, a biochip 3b implanted into the hypodermis of the user 4 or portable detecting equipment 3c. In addition, the control signal can be inputted to the personal digital assistant 2a via a data converting module included therein. As such, the user 4 can control and adjust the pacemaker 3a, the biochip 3b or the detecting equipment 3c via the personal digital assistant 2a whenever he/she wants. Alternatively, the wireless transmission approach can be implemented by a Bluetooth wireless transmission technology or an 802.11 wireless transmission technology.

The short-distance wireless transmission device for driving functions of medical equipment provided by the present invention, when comparing with other previous conventional technologies, has following advantages:

1. The short-distance wireless transmission device of the present invention allows the user to control and adjust medical equipment provided inside or outside his/her body in real time via a portable electronic communication product in a short-distance wireless transmission approach, thereby increasing safety and reducing waste of medical resources.

2. The short-distance wireless transmission device of the present invention can transmit a control signal to medical equipment having therein a signal receiving module within an effective distance via an IR wireless transmission technology, a Bluetooth wireless transmission technology, an 802.11 wireless transmission technology or a wideband wireless transmission technology.

3. The short-distance wireless transmission device of the present invention can transmit control command signal to related medical equipment via a mobile phone, a personal digital assistant, a notebook computer, a panel computer, a pocket computer or an independent control device so as to control the medical equipment.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A short-distance wireless transmission device for driving functions of medical equipment, said short-distance wireless transmission device comprising a data converting module and a signal emitting module integrated in an electronic product, control signal is subsequently transmitted by said signal emitting module via a wireless transmission approach to medical equipment having therein a signal receiving module, thereby controlling and adjusting said medical equipment.

2. The short-distance wireless transmission device for driving functions of medical equipment according to claim 1, wherein said wireless transmission approach is an IR wireless transmission technology.

3. The short-distance wireless transmission device for driving functions of medical equipment according to claim 1, wherein said wireless transmission approach is a Bluetooth wireless transmission technology.

4. The short-distance wireless transmission device for driving functions of medical equipment according to claim 1, wherein said wireless transmission approach is an 802.11 wireless transmission technology.

5. The short-distance wireless transmission device for driving functions of medical equipment according to claim 1, wherein said wireless transmission approach is a wideband wireless transmission technology.

6. The short-distance wireless transmission device for driving functions of medical equipment according to claim 1, wherein said wireless transmission approach is implemented by outputting said control signal via a continuously emitting mode.

7. The short-distance wireless transmission device for driving functions of medical equipment according to claim 1, wherein said wireless transmission approach is implemented by outputting said control signal via an intermittently emitting mode.

8. The short-distance wireless transmission device for driving functions of medical equipment according to claim 1, wherein said wireless transmission approach is implemented by outputting said control signal via a regularly emitting mode.

9. The short-distance wireless transmission device for driving functions of medical equipment according to claim 1, wherein said wireless transmission approach is implemented by outputting said control signal via a manually operated mode.

10. The short-distance wireless transmission device for driving functions of medical equipment according to claim 1, wherein said wireless transmission approach is implemented by outputting said control signal via an automatically emitting mode.

11. The short-distance wireless transmission device for driving functions of medical equipment according to claim 1, wherein said wireless transmission approach is implemented by outputting said control signal via a preset command control mode.

12. The short-distance wireless transmission device for driving functions of medical equipment according to claim 1, wherein said wireless transmission approach is implemented by outputting said control signal via a receiver driving mode.

13. The short-distance wireless transmission device for driving functions of medical equipment according to claim 1, wherein said electronic product is a mobile phone.

14. The short-distance wireless transmission device for driving functions of medical equipment according to claim 1, wherein said electronic product is a personal digital assistant.

15. The short-distance wireless transmission device for driving functions of medical equipment according to claim 1, wherein said electronic product is a notebook computer.

16. The short-distance wireless transmission device for driving functions of medical equipment according to claim 1, wherein said electronic product is a panel computer.

17. The short-distance wireless transmission device for driving functions of medical equipment according to claim 1, wherein said electronic product is a pocket computer.

18. The short-distance wireless transmission device for driving functions of medical equipment according to claim 1, wherein said electronic product is an independent control device.

19. The single-use safety injector structure according to claim 1, wherein said medical equipment is detecting equipment.

20. The single-use safety injector structure according to claim 1, wherein said medical equipment is testing equipment.

21. The single-use safety injector structure according to claim 1, wherein said medical equipment is monitoring equipment.

22. The single-use safety injector structure according to claim 1, wherein said medical equipment is therapeutic equipment.

23. The single-use safety injector structure according to claim 1, wherein said medical equipment is a pacemaker.

24. The single-use safety injector structure according to claim 1, wherein said medical equipment is a pump.

25. The single-use safety injector structure according to claim 1, wherein said medical equipment is ultrasonic device.

26. The single-use safety injector structure according to claim 1, wherein said medical equipment is a microelectronic device.

27. The single-use safety injector structure according to claim 1, wherein said medical equipment is a biochip.

28. The single-use safety injector structure according to claim 1, wherein said medical equipment is a nano-device

29. The single-use safety injector structure according to claim 1, wherein said medical equipment is disposed in the vicinity of the body.

30. The single-use safety injector structure according to claim 1, wherein said medical equipment is worn on the body.

31. The single-use safety injector structure according to claim 1, wherein said medical equipment is attached to the skin.

32. The single-use safety injector structure according to claim 1, wherein said medical equipment is implanted into hypodermis.

33. The single-use safety injector structure according to claim 1, wherein said medical equipment is implanted into the body.

34. The single-use safety injector structure according to claim 1, wherein said medical equipment is implanted into blood vessels.

35. The single-use safety injector structure according to claim 1, wherein said medical equipment is implanted into internal organs.

36. The single-use safety injector structure according to claim 1, wherein said medical equipment is swallowed into gastrointestinal tracts.

37. The single-use safety injector structure according to claim 1, wherein said medical equipment is implanted via an endoscope.
